(19) United States
(12) Patent Application Publication
(10) Pub. No.: US 2012/0232944 A1
(43) Pub. Date: Sep. 13, 2012

(54) RESOURCE SKILL COMPLIANCE OPTIMIZATION

(76) Inventors: Zhengyu Zhu, Shanghai (CN); Cipriano A. Santos, Modesto, CA (US); Wei-Hong Wang, Kitchener (CA); Maria Teresa Gonzalez Diaz, Mountain View, CA (US)

(21) Appl. No.: 13/045,764

(22) Filed: Mar. 11, 2011

(51) Int. Cl. G06Q 10/00

(52) U.S. Cl. 705/7.14

(57) ABSTRACT

Methods, apparatus, and computer readable media with executable instructions stored thereon for optimizing resource skill compliance are provided. Example methods of the present disclosure can include identifying jobs, skills corresponding to the jobs, and resources corresponding to the skills. A job skill level is associated with each skill of each job, and a resource skill level is associated with each skill of each resource. An individual skill compliance is determined by computer for each skill of each resource with respect to each skill of each job based on the resource skill level relative to the job skill level. A resource skill compliance is determined by computer for each resource with respect to each job as a total of the individual skill level compliances for each skill corresponding to each job, and resources are assigned by a computer to jobs in a manner that optimizes a total of the resource skill compliances for those resources assigned to jobs.

### BACKGROUND

Organizations can employ and/or manage large numbers of resources, which may be geographically dispersed. Resources may be people, equipment, services, etc. Resource management attempts to properly assign resources to organizational needs in an efficient manner. Resource management can be a dynamic, on-going process since organizational needs and available resources can grow, shrink, and/or change. For example, an organization may require more resources as it begins a new project or business venture.

One particular problem arising in resource management is to provide a qualified resource to the right job at the right time at an appropriate cost. Providing a resource with the right qualifications may entail providing necessary equipment to a project or task, and/or identifying a qualified candidate for a particular job. Assigning an over-qualified resource to a job can increase the cost of accomplishing the job if the resource cost is more than other resources capable of accomplishing the job. Assigning an under-qualified resource to a job can also result in increased cost if the resource isn't able to accomplish the job, in a timely manner, which can cause inefficiencies in a coordinated process. Leaving a job unfilled can likewise cost the organization due to inability to complete a project, inefficiencies, and/or penalties that may be incurred.

In a previous approach to identifying qualified candidates for jobs, human resource personnel may review resumes based on general criteria such as type of college degree and/or years of experience, which may or may not correspond to particular job title. Multiple candidates may be interviewed several times by various interested parties, with a selection made by a manager. The manual selection process can be slow, expensive, inefficient, and time-consuming, for candidates, human resource personnel, and those seeking the resource. In some instances, there may not be a candidate that possesses all the qualifications specified for the job, so identifying a best qualified candidate can become complex. The process can also be complex in large organizations due to the large numbers of resource events taking place at any given time.

### BRIEF DESCRIPTION OF THE DRAWINGS

FIG. 1 is a flow chart illustrating an example of a method for resource skill compliance optimization according to the present disclosure.

FIG. 2 illustrates an example system configured to optimize resource skill compliance according to the present disclosure.

FIG. 3 illustrates a block diagram of an example of a computing system for resource skill compliance optimization according to the present disclosure.

FIG. 4 illustrates a block diagram of an example of a computer readable medium (CRM) in communication with processing resources according to the present disclosure.

### DETAILED DESCRIPTION

Methods, apparatus, and computer readable media with executable instructions stored thereon for optimizing resource skill compliance are provided. Example methods of the present disclosure can include identifying jobs, skills corresponding to the jobs, and resources corresponding to the skills. A job skill level is associated with each skill of each job, and a resource skill level is associated with each skill of each resource. An individual skill compliance is determined by computer for each skill of each resource with respect to each skill of each job based on the resource skill level relative to the job skill level. A resource skill compliance is determined by computer for each resource with respect to each job as a total of the individual skill level compliances for each skill corresponding to each job, and resources are assigned by a computer to jobs in a manner that optimizes a total of the resource skill compliances for those resources assigned to jobs.

As used herein, an organization may be a business entity, but need not be limited to an entity having a commercial intent. As used herein, resources may refer to human and non-human resources, such as people, equipment, buildings, vehicles, services, assets, and the like. For example, resources may include employees, computer processing capability at a particular time or over some period of time, data storage hardware, and/or office space used by an organization, among others. As such, resource management can include workforce management (e.g., planning). While example implementations of the present disclosure are provided herein in the context of human resource staffing, example implementations of the present disclosure are not so limited. The reader will appreciate that the methods and systems of the present disclosure can be applied to other resource management scenarios, such as those involving non-human resources as well, as long as there are resource attributes for compliance.

As used herein, a job includes any function to which a resource may be assigned. For example, a job can be an employment situation, such as a professional services position that may be associated with a business entity or project associated with the business entity. A job can also be a task performed by an apparatus. For example, a job can be data storage performed by a storage device (e.g., memory), or a job can be a batch processing performed by one or more processors.

An organization, such as a business entity, can deliver a wide variety of products and/or services to customers. In order to operate most efficiently the organization strives to utilize resources with the right qualifications for the right job at the right time and for an appropriate cost. To that end, workforce management is used by an organization to maximize utilization of its workforce, minimize overall labor cost, and properly match job requirements with employee qualifications so as to successfully accomplish the job with consideration for employee morale.

One aspect of workforce management attempts to identify current and future gaps between the resources (e.g., workforce) available and the resources needed to provide the products and/or services of the organization. Workforce needs may be compartmentalized by sub-organizational divisions, such as departments, geographic locations, projects, etc. Workforce gap analysis can involve determining labor shortages (gaps) in desired skills and/or requisite experience, and over supply (gluts) of other skills and/or experience. Over supply of skills and/or experience can be a major cause of low utilization of labor within an organization. Labor shortages in certain skills and/or skill level can cause “emergency” sub-contracting, with associated higher third party labor procurement costs, delayed project delivery, lower quality due to rushed time lines, financial penalty for late delivery of products and/or services, and/or lower customer satisfaction, which can lead to lost business and revenue.

Example implementations of the present disclosure optimize the matching of job (e.g., position) skill requirements with employee skill qualifications. Previous approaches of matching job (e.g., position) attributes requirements with employee qualifications considered skills as a single atomic job attribute (e.g., skill-group, capability). One disadvantage of previous approaches is that the specific proficiency of an employee with respect to each skill in a skill-group was not explicitly considered.

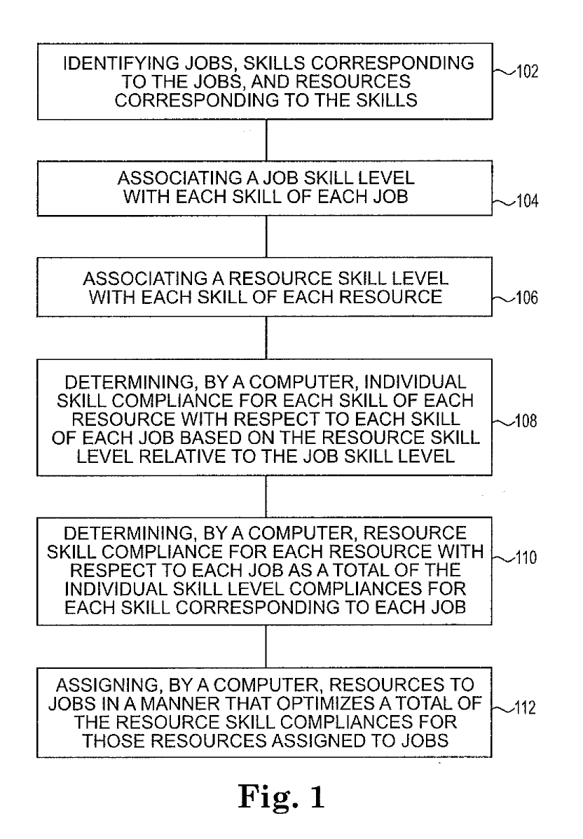

FIG. 1 is a flow chart illustrating an example of a method for resource skill compliance optimization according to the present disclosure. According to one or more example implementations of the present disclosure, a resource skill compliance optimization method and/or automated tool can be configured to fill job (e.g., position) requirements by allocating resources (e.g., employees) in an arrangement that maximizes a total resource skill compliance for an organization (i.e., organization compliance). Organization compliance is discussed further below.

FIG. 1 shows identifying jobs, skills corresponding to the jobs, and resources corresponding to the skills at 102. The method illustrated in FIG. 1 further shows a job skill level being associated with each skill of each job at 104, and a resource skill level associated with each skill of each resource at 106.

To demonstrate an application of the methods of the present disclosure, the following example matching problem is provided. An organization has two upcoming projects to staff. Project A requires 2 Senior Developers and 1 Junior Quality Assurance (QA) technician. Project B requires 1 Junior Developer and 1 Senior QA technician. This example staffing problem assumes a single period where all projects and employees under consideration are completely available during the single period planning horizon of the projects. However, example implementations of the present disclosure are not so limited, and the methods and systems discussed herein may be extrapolated to multiple planning periods by further specifying jobs and resources with respect to the respective time periods. The following discussion also assumes an employee is completely available during the single planning period; however, example implementations of the present disclosure are not so limited, and can also be extrapolated to partial employee availability and/or a need for an employee only part time during a given period (e.g., fractional full time equivalent (FTE)), for example, by expressing the position requirements for each position in a period as an FTE.

With respect to Project A, the two Senior Developer positions each require a Java skill at a skill level of 5 and an Oracle skill at skill level 2. The Senior Developer will utilize the Java skill approximately sixty percent (60%) of the time and the Oracle skill approximately forty percent (40%) of the time, so a weight (e.g., importance) of the Java skill for the Senior Developer position is set at 0.6. Similarly, the weight of the Oracle skill with respect to the Senior Developer position is set at 0.4.

With respect to Project A, the Junior GA position requires a Unix skill at skill level 3 and an Oracle skill at skill level 1. The Junior QA position is forecast to utilize the Unix skill approximately sixty percent (60%) of the time, so the weight of the Unix skill with respect to the Junior QA position is set at 0.6. The Junior QA position for project A is forecast to utilize the Oracle skill approximately forty percent (40%) of the time, so the weight of the Oracle skill with respect to the Junior QA position of Project A is set at 0.4.

With respect to Project B, the Junior Developer position requires a Java skill at skill level 3 and an Oracle skill at skill level 2. The Junior Developer position is forecast to utilize the Java skill half of the time and the Oracle skill the other half of the time, so the weights of the Java and Oracle skills with respect to the Junior Developer position of Project B are each set at 0.5.

With respect to the Senior QA position of Project B, the Senior QA position requires a Unix skill at skill level 4 and an Oracle skill at skill level 3. Again, it is forecast that the Senior QA position will utilize the Unix skill approximately half of the time and the Oracle skill the other half of the time, so the weights of the Unix and Oracle skills with respect to the Senior QA position of Project B are also each set at 0.5. Table 1 summarizes the identified jobs and skills corresponding to the jobs for this example.

TABLE 1

| | | Required | | Weight of |
|---|---|---|---|---|
| | | Required | Skill | Skill for |
| Project | Position | Skill | Level | Position |
| A | Senior Developers | Java | 5 | 0.6 |
| | | Oracle | 2 | 0.4 |
| | Junior QA | Unix | 3 | 0.6 |
| | | Oracle | 1 | 0.4 |
| B | Junior Developer | Java | 3 | 0.5 |
| | | Oracle | 2 | 0.5 |
| | Senior QA | Unix | 4 | 0.5 |
| | | Oracle | 3 | 0.5 |

Continuing with the example, the organization has 5 employees available. The Table 2 summarizes their respective skill level at various skills. Skill level can represent proficiency at a particular skill. Skill level can be based on an evaluation, reflect experience (e.g., years, projects), education attained, billing rate, pay grade, and/or be representative of some other criteria. For example, Andrew has a Java skill at a skill level of 5, but does not have an accounting skill since the skill level is indicated at a skill level of zero. Accounting is not a skill associated with any of the positions for Project A or B. A resource may have one or more skills that may not be associated with the currently available jobs. The reader will appreciate that future jobs, such as positions on other projects, may request more or different skills than those described in this example. The reader will also appreciate that from a listing of skills and/or skill levels corresponding to skills, resources corresponding to the skills of available jobs can be identified.

TABLE 2
(Employee Skill Levels)

Skill

| Employee | Java | Oracle | Unix | Accounting |
|---|---|---|---|---|
| Andrew | 5 | 2 | 2 | 0 |
| Joel | 3 | 2 | 2 | 0 |
| Pascal | 4 | 2 | 1 | 0 |
| Chris | 1 | 3 | 4 | 0 |
| Tom | 2 | 2 | 2 | 2 |

According to various example implementations, allocating employees to position requirements so as to maximize the resource skill compliance of the organization can be accomplished using linear programming. A linear programming model can be implemented using a commercially available modeling language and solved with a commercially available solver. Attached to this specification is an example program listing for resource skill compliance optimization by an example linear programming model. Linear programming is a mathematical programming approach used extensively in solving logistic problems having a number of variable and/or constraints. Linear algebra involving inequalities is used to simultaneously solve multiple criteria so as to converge a solution towards a maximum or minimum objective while satisfying the constraints.

The following sets and indices can be utilized with respect to jobs (e.g., positions), skills, and resources (e.g., employees):

pεP: Index of a position in set of positions

sεS: Index of a skill in set of skills

eεE: Index of an employee in set of employees available

According to various example implementations, the linear programming model of the described example can utilize the following parameters to associate a job skill level with each skill of each job, and associate a resource skill level with each skill of each resource:

posreq(p): Position requirements for position p

reqskillv(p,s): Required skill level for skill s and position p

posweight(p,s): Weight of skill s at position p

empskillv(e,s): Employee skill level for skill s and employee e

As discussed above, Table 1 shows the position requirements (e.g., skills) corresponding to each available position of the present example, as well as the required skill level for each skill of each position, and the weight of each skill of each position. As used in this example, a “required” skill level of a position refers to a skill level associated with the position. “Required” intends “requested” with respect to skill level, and does not necessarily mean a minimum skill level or that a resource must have the specified skill level. Skill level of a resource are compared against the skill level “required” (i.e., requested) for the position, as discussed below.

Table 2 shows the skill level of each available employee for various skills. Although the information of the present example is presented in a table format, example implementations of the present disclosure are not so limited, and such information may be stored in one or more databases on non-transient computer readable media, and related to one another as necessary to establish the associations discussed herein. Matrices can also be used to store and manipulate data, a particular entry of a matrix being addressed by one or more index value.

FIG. 1 shows determining, by a computer, individual skill compliance for each skill of each resource with respect to each skill of each job based on the resource skill level relative to the job skill level at 108. Individual skill compliance is a measure of how well an employee's skill level complies with the skill level associated with a position. That is, individual skill compliance involves an assessment of skill and skill level between a resource and a job (e.g., position). Individual skill compliance is determined with respect to individual skills. Subsequently, resource skill compliance is determined. Resource skill compliance is distinguished from individual skill compliance. Resource skill compliance is effectively a comparison of all the skills associated with a position with all the skills provided by a particular resource.

One way to measure individual skill compliance is to compare the skill level of an employee with respect to a particular skill to the required skill level of a position for the particular skill. This comparison is done on a skill-by-skill basis for all the skills required by all the positions. Mathematically, this can be accomplished by dividing an employee skill level for a particular skill by the skill level of the particular skill required by a position. In a linear programming model of the described example, the following parameter can be computed from the initial parameters to determine individual skill compliance:

epscore(e,s,p): Score of employee e compliance for individual skill s required by position p, where:

epscore(e,s,p)=empskillv(e,s)/reqskillv(p,s)

Each resulting quantity will indicate a particular employee's skill level relative to the skill level required by a position. The indices indicate that the “epscore” parameter is determined for each employee, skill and position combination so that respective employee skills are compared with each of the skills required by each of the positions. Table 3 summarizes the employee skill level divided by the required skill level for each skill of each position, referred to herein as the raw employee skill compliance. For example, Table 1 indicates that the Senior Developer position of Project A requires a Java skill at skill level 5. Table 2 indicates Andrew has a skill level of 5 in the Java skill. Dividing Andrew's Java skill level of 5 by the Project A Senior Developer position required skill level for Java of 5 results in a ratio equal to 1, as shown in Table 3 corresponding to Andrew and the Java skill of the Senior Developer position. Similar ratios are determined for each of the skills of positions and employees. Calculations with respect to accounting skills are omitted from Table 3 since no currently available position requires the accounting skill.

TABLE 3
(Raw Employee Skill Compliance)

| | Positions, Skills, and Skill Weight | | | | | | | |
|---|---|---|---|---|---|---|---|---|
| | | | | | JrDev | | SrQA | |
| | SrDevs (2) | | JrQA | | | Ora- | | Ora- |
| | Java | Oracle | Unix | Oracle | Java | cle | Unix | cle |
| Employee | (0.6) | (0.4) | (0.6) | (0.4) | (0.5) | (0.5) | (0.5) | (0.5) |
| Andrew | 1 | 1 | 0.67 | 2 | 1.67 | 1 | 0.5 | .67 |
| Joel | 0.6 | 1 | 0.67 | 2 | 1 | 1 | 0.5 | .67 |
| Pascal | 0.8 | 1 | 0.33 | 2 | 1.33 | 1 | 0.25 | .67 |
| Chris | 0.2 | 1.5 | 1.33 | 3 | 0.33 | 1.5 | 1 | 1 |
| Tom | 0.4 | 1 | 0.67 | 2 | 0.67 | 1 | 0.5 | .67 |

The reader will appreciate that an individual skill compliance ratio equal to a minimum value (e.g., zero) is determined where a position requires a particular skill that a particular employee does not have at a sufficient level (e.g., a zero employee skill level divided by a non-zero position skill level). A non-zero minimum value for the quotient is possible where a skill level threshold different than zero is deemed unqualified. An individual skill compliance ratio greater than the minimum value (e.g., zero) but less than a maximum value (e.g., 1) indicates the employee has some of a particular skill, but not as much skill level as that required by a particular position. An individual skill compliance ratio equal to the maximum value (e.g., one) indicates the employee has a same skill level for a particular skill that is required by a particular position. An individual skill compliance ratio greater than the maximum value (e.g., one) indicates the employee has more skill level for a particular skill than is required by a particular position. Ranges other than from zero to one are contemplated, based on the values used to measure individual skill level and required position skill level, the other ranges having a minimum value indicative of a particular resource being unqualified with respect to a particular position, and a maximum value indicative of the particular resource being fully qualified with respect to a particular position.

For example, Table 1 indicates that the Junior QA position of Project A requires an Oracle skill at skill level 1. Table 2 indicates Andrew has a skill level of 2 in the Oracle skill. Dividing Andrew's Oracle skill level of 2 by the Project A Junior QA position required skill level for Oracle of 1 results in a ratio equal to 2, as shown in Table 3 corresponding to Andrew and the Oracle skill of the Junior QA position. That is, Andrew has a higher Oracle skill level than is required by the Project A Junior QA position.

Whether extra skill level, above that required by a particular position, is view by an organization as being beneficial or not, can be incorporated into the methods of the present disclosure. If additional skill is beneficial, the raw employee skill compliance ratio can be used for additional calculations. If additional skill of a resource with respect to a particular skill of a position is not viewed as being beneficial, an employee's skill compliance can be clamped to be at most equal to a value (e.g., ratio) equal to one. That is, if the employee skill level is equal to or greater than the required sill level of a skill of a position, the individual skill compliance value can be limited to indicate a value corresponding to full individual skill compliance (but no more so as not to overly influence the resource-position matching process).

Clamping can be accomplished in the linear programming model of the described example by the determination a skillcomp(e,s,p) parameter to be the lesser of a maximum value indicative of a resource being fully qualified for a position (e.g., 1) or the raw employee skill compliance value (shown in Table 3) as follows:

skillcomp(e,s,p): Skill compliance of employee e with skill s required by position p, where:

skillcom(e,s,p)=Min(1,epscore(e,s,p))

That is, a clamped individual skill compliance can be determined directly the minimum of (1, employee skill level/position skill level).

Table 4 summarizes the clamped employee skill level values for each skill of each position corresponding to the raw employee skill compliance values shown in Table 3. The reader will observe that raw employee skill level values greater than the maximum value (e.g., 1) are clamped to equal the maximum value (e.g., 1) in determining the clamped employee skill level values. For example, the Oracle skill compliance for Andrew with respect to the Junior QA position has a raw employee skill compliance value of 2, which is clamped to a value of 1.

TABLE 4
(Clamped Employee Skill Compliance)

| | Positions and Skills | | | | | | | |
|---|---|---|---|---|---|---|---|---|
| | | | | | JrDev | | SrQA | |
| | SrDevs (2) | | JrQA | | | Ora- | | Ora- |
| | Java | Oracle | Unix | Oracle | Java | cle | Unix | cle |
| Employee | (0.6) | (0.4) | (0.6) | (0.4) | (0.5) | (0.5) | (0.5) | (0.5) |
| Andrew | 1 | 1 | 0.67 | 1 | 1 | 1 | 0.5 | .67 |
| Joel | 0.6 | 1 | 0.67 | 1 | 1 | 1 | 0.5 | .67 |
| Pascal | 0.8 | 1 | 0.33 | 1 | 1 | 1 | 0.25 | .67 |
| Chris | 0.2 | 1 | 1 | 1 | 0.33 | 1 | 1 | 1 |
| Tom | 0.4 | 1 | 0.67 | 1 | 0.67 | 1 | 0.5 | .67 |

According to some example implementations of the present disclosure, to avoid certain over qualified cases, a raw employee skill compliance over-qualification threshold can be defined in such a way that whenever the ratio of employee skill level divided by a position skill level is greater than the overqualified threshold the value of the raw employee skill compliance, clamped employee skill compliance, and/or resource skill compliance (discussed below) can be set to the minimum value (e.g., zero) indicative of a particular resource being unqualified with respect to a particular position. As discussed earlier, a raw or clamped employee skill compliance of the minimum value (e.g., zero) indicates that the employee does not have a particular skill required by a position. A resource skill compliance at the minimum value indicates that the employee is unqualified (e.g., not qualified) for a particular position. In this instance, the employee is deemed unqualified because they are over-qualified in some capacity to fill the position. Over-qualification can be more expensive than is necessary where the over-qualified employee is compensated based on the over-qualified skill level. The reader will appreciate that such a raw employee skill compliance over-qualification threshold can be defined so as to allow minor over-qualifications (e.g., greater than 1.2) but to disqualify grossly over-qualified candidates.

FIG. 1 shows determining, by a computer, resource (e.g., employee) skill compliance for each resource with respect to each job as a total of the individual skill level compliances for each skill corresponding to each job at 110. A resource skill compliance (alternately referred to herein as a position compliance) is a total of an employee's individual skill compliances for a position for each resource-position combination. According to some example implementations, the individual skill compliance can be weighted with respect to a particular position to account for the relative importance and/or expected use of various skills with respect to a particular position. The weight associated with a particular position can be set to a billing rate associated with the position, for example. Tables 3 and 4 parenthetically indicate the weights associated with each skill for each position. For example, the Senior developer position Java skill is weighted as 0.6 (i.e., 60% of the total skill required for the position) and the Oracle skill is weighted as 0.4 (i.e., 40% of the total skill required for the position).

Resource (e.g., employee) skill compliance can be determined in the linear programming model of the described example by calculation of the following parameter:

$$poscomp ( e , p ) : Employee e compliance with position p . \\ poscomp ( e , p ) = {\sum }_{s} skillcom ( e , s , p ) * posweight ( p , s )$$

The resource (e.g., employee) skill compliance is determined for each employee with respect to each position as the sum of all individual skill compliances multiplied by the weight for each respective skill with respect to a position. From the weights indicated in Table 4, the reader will understand that a skill may have different weights with respect to different positions. For example, an Oracle skill is shown having a 0.4 weight with respect to the Senior Developer and Junior QA positions, but a 0.5 weight with respect to the Junior Developer and Senior QA positions.

Table 5 summarizes resource (e.g., employee) skill compliance for the example problem presented herein. The resource (e.g., employee) skill compliance values shown in Table 5 can be calculated from the (clamped) individual skill compliance values and weights shown in Table 4. For example, with respect to the Senior Developer position, Andrew has a Java individual skill compliance value of 1 at a weight of 0.6 and an Oracle individual skill compliance value of 1 at a weight of 0.4. The resource (e.g., employee) skill compliance value for Andrew with respect to the Senior Developer position is (1*0.6)+(1*0.4)=(0.6)+(0.4)=1. With respect to the Junior QA position, Andrew has a Unix individual skill compliance value of 0.67 at a weight of 0.6 and an Oracle individual skill compliance value of 1 at a weight of 0.4. The resource (e.g., employee) skill compliance value for Andrew with respect to the Junior QA position is (0.67*0.6)+(1*0.4)=(0.4)+(0.4)=0.8.

TABLE 5
(Employee Position Compliance)

Skills

| Employee | SrDev | JrQA | JrDev | SrQA |
|---|---|---|---|---|
| Andrew | 1 | 0.8 | 1 | 0.58 |
| Joel | 0.76 | 0.8 | 1 | 0.58 |
| Pascal | 0.88 | 0.6 | 1 | 0.46 |
| Chris | 0.52 | 1 | 0.67 | 1 |
| Tom | 0.64 | 0.8 | 0.83 | 0.58 |

Once compliance of employees are computed with respect to each available position, a set of employees having non-zero resource (e.g., employee) skill compliance with respect to a particular position and that can possibly fill a position can be identified. This can be accomplished in a linear programming model of the described example as follows:

EP={(e,p):poscomp(e,p)>0}:Set of employees e able to fill position p.

The reader will appreciate that a resource (e.g., employee) skill compliance value of 1 indicates complete matching of an employee's skills with those of a position. Considering the results presented in Table 5 of this simple example reveals that Andrew's skills and skill levels are a complete match for either of the Senior Developer or Junior Developer positions. However, Joel and Pascal are also complete matches for the Junior Developer position. Therefore, Andrew should be assigned to one of the two Senior Developer positions and either one of Joel or Pascal should be assigned to the Junior Developer position. Since Pascal is more qualified than Joel with respect to the second Senior Developer position of Project A, Joel should be assigned to the Junior Developer position and Pascal should be assigned to the second Senior Developer position. Chris' skills are a complete match for both of the QA positions. If Chris is assigned to the Junior QA position then the next best resource (e.g., employee) skill compliance value for the remaining Senior QA position is only 0.58 (e.g., Tom). If Chris is assigned to the Senior QA position then the next best resource (e.g., employee) skill compliance value for the remaining Junior QA position is 0.8 (e.g., Tom). Therefore, Chris should be assigned to the Senior QA position and Tom should be assigned to the Junior QA position. Table 6 summaries the above-discussed qualitative results.

TABLE 6
(Allocation)

Skills

| Employee | SrDev | JrQA | JrDev | SrQA |
|---|---|---|---|---|
| Andrew | 1 | | | |
| Joel | | | 1 | |
| Pascal | 0.88 | | | |
| Chris | | | | 1 |
| Tom | | 0.8 | | |

To facilitate a solution implemented by one or more processors, a quantitative method is provided. According to various example implementations of the present disclosure, resources (e.g., employees) are assigned to jobs (e.g., positions) in a manner that optimizes a total of the resource skill compliances for those resources assigned to jobs. Alternatively, resources (e.g., employees) are assigned to jobs (e.g., positions) in a manner that optimizes an average of the resource skill compliances for those resources assigned to jobs.

The selection of particular employees to fill particular positions can be determined quantitatively via a linear programming model of the described example by a formulation that maximizes total organization compliance (e.g., z), as follows:

$$Max z = {\sum }_{( e , p )} poscomp ( e , p ) * {x}_{e , p}$$

Organization compliance is thereby defined as a total of the resource (e.g., employee) skill compliances for those resources (e.g., employees) assigned to jobs (e.g., positions). The reader will appreciate that a solution can also be equivalently determined by maximizing average organization compliance. Alternately, total organization compliance can be optimized, which can include maximum and near-maximum values. Optimizing will be appreciated as intending obtaining an efficient solution, such as a solution that exceeds a pre-defined threshold of performance.

A linear programming approach can try many different combinations of employees assigned to different positions and compare the resulting value of organization compliance. For the various combinations, selection of a particular employee from the set of employees that can possibly fill a position (e.g., EP) can be indicated in the linear programming model of the described example by setting the following decision variable:

x_{e,p}≧0:allocation of employee e to position p

In this manner, an employee e compliance with position p will only be effectively included in the summation for an employee selected from the set of employees that can possibly fill a position where x_{e,p}≧0, since x_{e,p}=0 for non-selected employees. Where x_{e,p}=0 for non-selected employees, the product with the resource (e.g., employee) skill compliance will also be zero and not contribute towards maximizing the organization compliance.

Partial allocations can be accommodated by methods of the present disclosure by setting the allocation value x_{e, p} to a value between 0 and 1, representative of a fractional full time equivalent (FTE) assignment of an employee to a position. The linear programming model of the described example seeks to satisfy employee capacity and position requirements. For each available employee eεE the linear programming model of the described example tries to satisfy the following constraint

$${\sum }_{p ∈ EP} {x}_{e , p} \leq 1$$

For each position pεP to be filled, the linear programming model of the described example also tries to satisfy the following position requirements constraint

$${\sum }_{e ∈ EP} {x}_{e , p} = posreq ( p )$$

where posreq(p) are the position requirements for position p. That is, allocation value x_{e,p} to a value equal to the FTE requirements of the particular position. For example, if Project B needed half of an FTE Senior QA technician, this partial allocation can be accounted for in a linear programming model of the described example by setting the allocation value x_{e,p} of the Senior QA technician to a value of 0.5.

The linear programming model of the described example can be easily extended to consider priorities for projects. That is, certain projects may be deemed more important to an organization, and thus can include a weighting factor for all positions associated with a project such that a total (or average) organizational compliance favors filling positions of more important projects over positions on less important projects. Other weighting schemes can be utilized with the quantitative matching methods of the present disclosure. In addition, the linear programming model of the described example can be extended to consider FTE employee availability where an employee is available at less than 100% during one or more planning periods.

Table 6 contains the optimal allocation of employees to fill the skill requirements of each of the positions, indicating the employee position compliance based on the optimal allocation. The total organizational compliance for the optimal solution found is equal to 1+1+1+0.88+0.8=4.68, and the average organizational compliance for the optimal solution found is equal to 4.68/5=0.936.

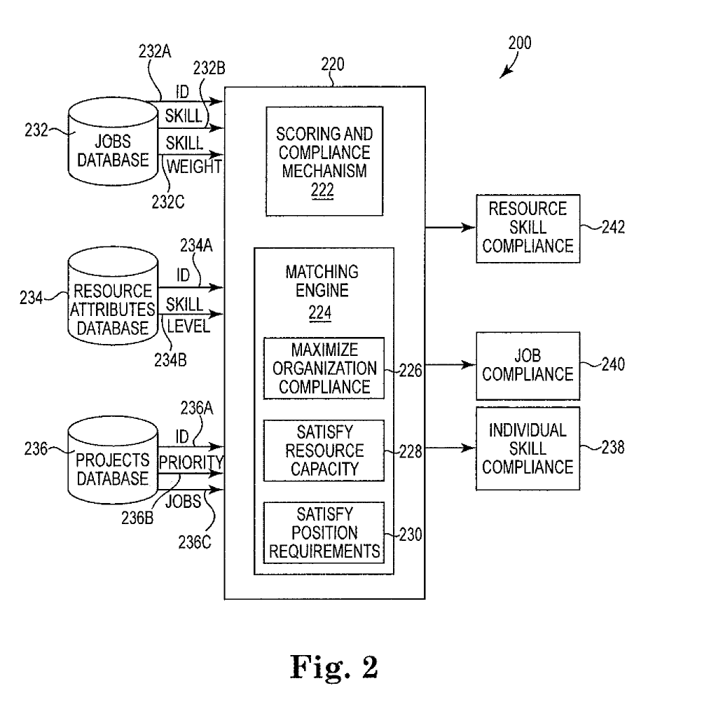

FIG. 2 illustrates an example system configured to optimize resource skill compliance according to the present disclosure. FIG. 2 illustrates a resource skill compliance optimization system 201, according to an example implementation. The resource skill compliance optimization system 201 may be implemented in software, hardware or a combination of hardware and software. The resource skill compliance optimization tool 201 may be software stored on a non-transient computer readable storage device, and executed by a computer system.

The resource skill compliance optimization system 201 includes a resource skill compliance optimization tool 220 that includes a scoring and compliance mechanism 222 and a matching engine 224. The matching engine includes logic to maximize organization compliance 226, satisfy resource capacity 228, and satisfy position requirements 230, as described with respect to FIG. 1. The matching engine 224 may be implemented using mixed integer programming and/or linear programming models. The resource skill compliance optimization tool 220 is connected to a jobs database 232, a resource attributes database 234, and a projects database 236.

The jobs database 232 stores attributes for each job, including a job identifier 232A, information regarding one or more job skills 234B associated with a respective job, and information regarding a skill weight 232C associated with a respective job skill 232B. The information regarding the one or more job skills can identify the skill and a skill level required by a respective job.

The resource attributes database 234 stores resource attributes for each resource, including a resource identifier 234A, and information regarding one or more resource skills 234B associated with a respective resource. The information regarding the one or more resource skills can identify the skill and skill level associated with a respective resource. For example, the qualifications of each candidate for a job, which may be taken from a resume, are entered in the resource attributes database 234 as resource attributes.

The projects database 236 stores project attributes for each project, including a project identifier 236A, project priority information 236B, and information regarding one or more jobs 236C associated with a respective project. For example, the resources and their corresponding qualifications needed for a new project may be specified as part of the project design/planning, and entered into the projects database.

For one or more time periods, the scoring and compliance mechanism 222 determines individual skill compliance for each skill of each resource with respect to each skill of each job based on the resource skill level relative to the job skill level. For example, the scoring and compliance mechanism 222 can calculate the raw and/or clamped employee skill compliance as described above. The scoring and compliance mechanism 222 can also operate to disqualify over-qualified resources, for example, by use of an over-qualification threshold, also described above.

The matching engine 224 can operate to determine resource skill compliance for each resource with respect to each job as a total of the individual skill level compliances for each skill corresponding to each job, and assign resources to jobs in a manner that optimizes a total of the resource skill compliances for those resources assigned to jobs, as described previously with respect to FIG. 1. The resource skill compliance optimization tool 220 may output individual skill compliance 238, including raw and/or clamped values, such as are shown above in Tables 3 and 4 for combinations of resource (e.g., employee), project, job, and/or skill.

The resource skill compliance optimization tool 220 may also output job (e.g., position) compliance 240, with or without position and project weighting, such as is shown above in Table 5 for combinations of resource (e.g., employee), project, job, and/or skill.

The resource skill compliance optimization tool 220 may also output resource skill compliance 242 to indicate a solution for assigning a particular resource (e.g., employee) to a particular job (e.g., position), such as is shown above in Table 6. The resource skill compliance output 242 can include a measure of organizational compliance (maximum or average per resource-job match), as discussed previously.

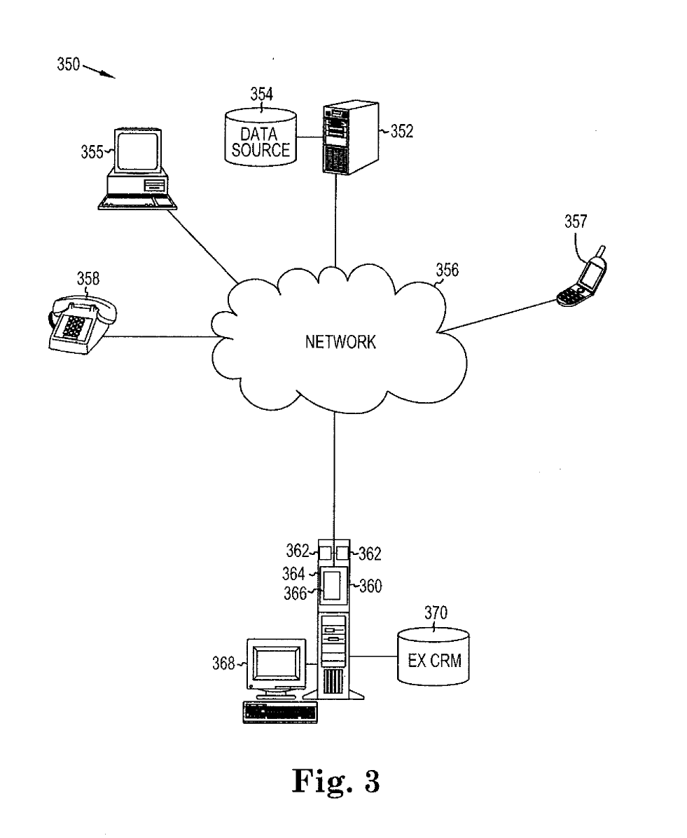

FIG. 3 illustrates a block diagram of an example of a computing system for resource skill compliance optimization according to the present disclosure. The computing system 350 comprises a number of computing resources communicatively coupled to the network 356. FIG. 3 shows a first computing device 352 that may also have an associated data source 354, and may have one or more input/output devices (e.g., keyboard, electronic display). A second computing device 360 is also shown in FIG. 3 being communicatively coupled to the network 356, such that executable instructions may be communicated through the network between the first and second computing devices.

Second computing device 360 may include one or more processors 362 communicatively coupled to a non-transitory computer-readable medium 364. The non-transitory computer-readable medium 364 may be structured to store executable instructions 366 (e.g., one or more programs) that can be executed by the one or more processors 362 and/or data. The second computing device 360 may be further communicatively coupled to a production device 368 (e.g., electronic display, printer, etc.). Second computing device 360 can also be communicatively coupled to an external computer-readable memory 370.

The second computing device 360 can cause an output to the production device 368, for example, as a result of executing instructions of one or more programs stored non-transitory computer-readable medium 364, by the at least one processor 362, to implement a system for resource skill compliance optimization according to the present disclosure. Causing an output can include, but is not limited to, displaying text and images to an electronic display and/or printing text and images to a tangible medium (e.g., paper). Executable instructions to determine resource skill compliance optimization may be executed by the first 352 and/or second 360 computing device, stored in a database such as may be maintained in external computer-readable memory 370, output to production device 368, and/or printed to a tangible medium.

One or more computers 355 (e.g., customer-owned computers), telephones 358, and/or portable communication devices 357, used to communicate with a system for resource skill compliance optimization, may also be communicatively coupled to the network 356. Computers 355, telephones 358, and/or portable communication devices 357 may be communicatively coupled to the network 356 via a communication link that includes a wireless portion. The telephones 358 and/or portable communication devices 357 may be computing devices, and/or may include processing resources.

First 352 and second 360 computing devices are communicatively coupled to one another through the network 356. While the computing system is shown in FIG. 3 having only two computing devices, the computing system can be comprised of additional multiple interconnected computing devices, such as server devices and/or clients. Each computing device can include control circuitry such as a processor, a state machine, application specific integrated circuit (ASIC), controller, and/or similar machine. As used herein, the indefinite articles “a” and/or “an” can indicate one or more than one of the named object. Thus, for example, “a processor” can include one processor or more than one processor, such as a parallel processing arrangement.

The control circuitry can have a structure that provides a given functionality, and/or execute computer-readable instructions that are stored on a non-transitory computer-readable medium (e.g., 354, 364, 370). The non-transitory computer-readable medium can be integral (e.g., 364), or communicatively coupled (e.g., 354, 370), to the respective computing device (e.g. 352, 360), in either in a wired or wireless manner. For example, the non-transitory computer-readable medium can be an internal memory, a portable memory, a portable disk, or a memory located internal to another computing resource (e.g., enabling the computer-readable instructions to be downloaded over the Internet). The non-transitory computer-readable medium (e.g., 354, 364, 370) can have computer-readable instructions stored thereon that are executed by the control circuitry (e.g., processor) to provide a particular functionality.

The non-transitory computer-readable medium, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), among others. The non-transitory computer-readable medium can include optical discs, digital video discs (DVD), high definition digital versatile discs (HD DVD), compact discs (CD), laser discs, and magnetic media such as tape drives, floppy discs, and hard drives, solid state media such as flash memory, EEPROM, phase change random access memory (PCRAM), as well as other types of machine-readable media.

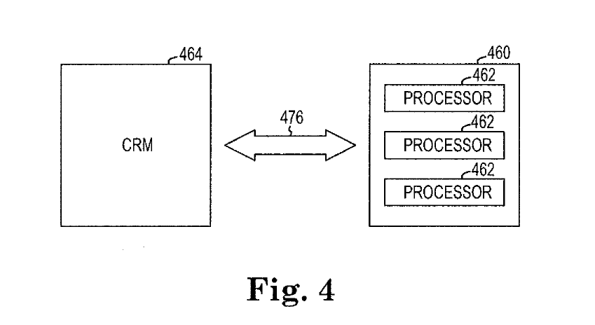

FIG. 4 illustrates a block diagram of an example of a computer readable medium (CRM) 464 in communication with processing resources 460 according to the present disclosure. As used herein, processor resources 460 can include one or a plurality of processors 462 such as in a parallel processing arrangement. A computing device having processor resources can be in communication with, and/or receive a tangible non-transitory computer readable medium (CRM) 464 storing a set of computer readable instructions (e.g., software) for capturing and/or replaying network traffic, as described herein.

As used herein, the indefinite articles “a” and/or “an” can indicate one or more than one of the named object. Thus, for example, “a processor” can include one processor or more than one processor. Processor resources can be also be control circuitry that can have a structure that provides a given functionality, and/or execute computer-readable instructions that are stored on an internal or external non-transitory computer-readable medium.

Non-transitory computer-readable medium (e.g., 464), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), high definition digital versatile discs (HD DVD), compact discs (CD), and/or a solid state drive (SSD), flash memory, etc., as well as other types of machine-readable media.

The non-transitory computer-readable medium can be integral, or communicatively coupled, to a computing device, in either in a wired or wireless manner. For example, the non-transitory computer-readable medium can be an internal memory, a portable memory, a portable disk, or a memory located internal to another computing resource (e.g., enabling the computer-readable instructions to be downloaded over the Internet). The non-transitory computer-readable medium can have computer-readable instructions stored thereon that are executed by the processing resources (e.g., control circuitry, processor(s)) to provide a particular functionality. The CRM 464 can be in communication with the processing resources 460 via a communication path 476. The communication path 476 can be local or remote to a machine associated with the processing resources 460.

In other examples, the communication path 476 can be such that the CRM 464 is remote from the processing resources 460 such as in the example of a network connection between the CRM 464 and the processing resources 460 (e.g., the communication path 476 can be a network connection). Examples of such a network connection can include a local area network (LAN), a wide area network (WAN), a personal area network (PAN), the Internet, among others. In such examples, the CRM 464 may be associated with a first computing device (e.g., a server) and the processing resources 460 may be associated with a second computing device (e.g., a client). The first and second computers can be in communication via a networked communication path 476.

Logic can be used to implement the method(s) of the present disclosure, in whole or part. Logic can be implemented using appropriately configured hardware and/or software. The above-mention logic portions may be discretely implemented and/or implemented in a common arrangement.

The above specification, including examples and data, provide a description of the method, applications, and use of the system and method of the present disclosure. Since many examples can be made without departing from the spirit and scope of the system and method of the present disclosure, this specification merely sets forth some of the many possible example configurations and implementations. Some features are grouped together in a single example implementation for the purpose of streamlining the disclosure. This method of disclosure is not to be interpreted as reflecting an intention that the disclosed examples of the present disclosure have to use more features than are expressly recited in each claim. Inventive subject matter lies in less than all features of a single disclosed example implementation. Thus, the following claims are hereby incorporated into the Detailed Description, with each claim standing on its own as a separate example implementation.

Although specific examples have been illustrated and described herein, those of ordinary skill in the art will appreciate that an arrangement calculated to achieve the same results can be substituted for the specific examples shown. It is to be understood that the above description has been made in an illustrative fashion, and not a restrictive one. Examples set forth in this specification are not intended to be limiting and merely set forth some of the many possible examples for the claimed system and method for resource skill compliance optimization.

In the foregoing discussion of the present disclosure, reference is made to the accompanying drawings that form a part hereof, and in which is shown by way of illustration how examples of the disclosure may be practiced. It is to be understood that other examples may be utilized and that process, electrical, and/or structural changes may be made without departing from the scope of the present disclosure. The figures attempt to follow a numbering convention in which the first digit corresponds to the drawing figure number and the remaining digits identify an element or component in the drawing. Similar elements or components between different figures may be identified by the use of similar digits. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

### Program Listing

The following is an example of a program listing for skill compliance optimization by a linear programming model implemented in a commercially available modeling language and solved with a commercially available solver GAMS.

```
======================================================
Skill Compliance Allocation Problem (SCAP)
This is an assignment problem that maximizes organizational compliance.
  Where
  Org_comp = avg(position compliance*position weight)
  pos_comp = avg(skill compliance*skill weight)
  skill_comp = min(1, candidate skill score/position skill requirement)
======================================================
27
28
29 Sets
30 p positions / SrDev,JrQA,JrDev,SrQA/
31 s skill / Java,Oracle,Unix /
32 e employees /Andrew,Joel,Pascal,Chris,Tom/
33 ;
34
35 display p,s,e;
36
37 Set ps(p,s) skill requirement at positions
38 /
39 SrDev.Java
40 SrDev.Oracle
41 JrQA.Unix
42 JrQA.Oracle
43 JrDev.Java
44 JrDev.Oracle
45 SrQA.Unix
46 SrQA.Oracle
47 /
48 ;
49
50 Set es(e,s) employee skills
51 /
52 Andrew.Java
53 Andrew.Oracle
54 Andrew.Unix
55 Joel.Java
56 Joel.Oracle
57 Joel.Unix
58 Pascal.Java
59 Pascal.Oracle
60 Pascal.Unix
61 Chris.Java
62 Chris.Oracle
63 Chris.Unix
64 Tom.Java
65 Tom.Oracle
66 Tom.Unix
67 /
68 ;
69
70 parameter posreq(p) position requirements
71 /
72 SrDev 2
73 JrQA 1
74 JrDev 1
75 SrQA 1
76 /;
77 display posreq;
78
79 parameter reqskillv(p,s) required skill level at positions
80 /
81 SrDev.Java 5
82 SrDev.Oracle 2
83 JrQA.Unix  3
84 JrQA.Oracle 1
85 JrDev.Java 3
86 JrDev.Oracle 2
87 SrQA.Unix  4
88 SrQA.Oracle 3
89 /
90 ;
91 display reqskillv;
92
93 parameter posweight(p,s) weight for skill positions
94 /
95 SrDev.Java 0.6
96 SrDev.Oracle 0.4
97 JrQA.Unix  0.6
98 JrQA.Oracle 0.4
99 JrDev.Java 0.5
100 JrDev.Oracle 0.5
101 SrQA.Unix  0.5
102 SrQA.Oracle 0.5
103 /
104 ;
105 display posweight;
106
107 parameter empskillv(e,s) employee skill level
108 /
109 Andrew.Java 5
110 Andrew.Oracle 2
111 Andrew.Unix 2
112 Joel.Java  3
113 Joel.Oracle 2
114 Joel.Unix  2
115 Pascal.Java 4
116 Pascal.Oracle 2
117 Pascal.Unix 1
118 Chris.Java 1
119 Chris.Oracle 3
120 Chris.Unix  4
121 Tom.Java 2
122 Tom.Oracle  2
123 Tom.Unix 2
124 /
125 ;
126 display empskillv;
127
128
*=====================================================
129 * Computed parameters
130
*=====================================================
131
132 parameter epscore(e,s,p) employee position compliance score;
133 epscore(e,s,p)$reqskillv(p,s) = empskillv(e,s)/reqskillv(p,$);
134 display epscore;
135
136 parameter skillcomp(e,s,p) skill compliance;
137 skillcomp(e,s,p) = min(1,epscore(e,s,p));
138 display skillcomp;
139
140 parameter poscomp(e,p) employee position compliance;
141 poscomp(e,p) = sum(s$ps(p,s), posweight(p,s)*skillcomp(e,s,p) );
142 display poscomp;
143
144
*=====================================================
145 * Linear Programming Model:
146
*=====================================================
147
148 Variables
149 x(e,p) 1 if employee e assigned to position p
150 z total organizational compliance ;
151
152 Positive Variable x ;
153
154 Equations
155 totcomp define objective function
156 supply(e) observe supply limit
157 demand(p) satisfy demand;
158
159
160 totcomp .. z =e= sum((e,p), poscomp(e,p)*x(e,p) ) ;
161
162 supply(e) .. sum(p$poscomp(e,p), x(e,p) ) =l= 1 ;
163
164 demand(p) .. sum(e$poscomp(e,p), x(e,p) ) =e= posreq(p) ;
165
166 Model compliance /all/ ;
167
168 Solve compliance using lp maximize z ;
169
170 scalar orgcomp avg organizational compliance;
171 orgcomp = z.l/sum(p,posreq(p));
172 option orgcomp:2:0:1; display orgcomp;
173
174 Display x.l, x.m ;
```

What is claimed:

1. A method for resource skill compliance optimization, comprising:
identifying jobs, skills corresponding to the jobs, and resources corresponding to the skills;
associating a job skill level with each skill of each job;
associating a resource skill level with each skill of each resource;
determining, by a computer, individual skill compliance for each skill of each resource with respect to each skill of each job based on the resource skill level relative to the job skill level;
determining, by a computer, resource skill compliance for each resource with respect to each job as a total of the individual skill level compliances for each skill corresponding to each job; and
assigning, by a computer, resources to jobs in a manner that optimizes a total of the resource skill compliances for those resources assigned to jobs.

2. The method as set forth in claim 1, further comprising identifying a weight corresponding to each skill of a particular one of the jobs, wherein determining a resource skill compliance for each resource with respect to each job includes adjusting each individual skill compliance by the weight of the corresponding skill of the particular one of the jobs.

3. The method as set forth in claim 1, wherein determining the individual skill compliance for each skill of each resource with respect to each skill of each job includes dividing the resource skill level by the job skill level for each skill.

4. The method as set forth in claim 3, wherein determining the individual skill compliance for each skill of each resource with respect to each skill of each job is set to a maximum value for a particular skill when the resource skill level is greater than the job skill level.

5. The method as set forth in claim 3, wherein determining the individual skill compliance for each skill of each resource with respect to each skill of each job is set to a minimum value for a particular skill when the resource skill level is greater than the job skill level by a predetermined amount.

6. The method as set forth in claim 1, further comprising determining the subset of the resources that can be assigned to each job, wherein the resource skill compliance for each resource in the subset of resources that can be assigned to a particular job is greater than a minimum value.

7. The method as set forth in claim 6, wherein assigning resources to jobs includes, for each job, selecting a particular resource from the subset of the resources that can be assigned to a particular job.

8. The method as set forth in claim 7, wherein assigning resources to jobs includes assigning a resource to at most one job.

9. The method as set forth in claim 8, further comprising identifying projects, wherein jobs correspond to projects, and each project has a priority, and wherein assigning resources to jobs includes assigning a resource to a job corresponding to a project having a greater priority before assigning a resource to a job corresponding to a project having a lesser priority.

10. The method as set forth in claim 7, wherein assigning resources to jobs includes assigning a resource to at most one or more jobs having a collective full time equivalent (FTE) equal to an FTE availability of the resource.

11. The method as set forth in claim 1, wherein assigning resources to jobs includes evaluating various assignments of resources to jobs utilizing mathematical optimization techniques involving mixed integer and/or linear programming.

12. A non-transitory computer-readable medium having computer-readable instructions stored thereon that, if executed by one or more processors, cause the one or more processors to:
identify positions, skills required by the positions, and employees having the skills;
associate a position skill level with each skill required of each position;
associate an employee skill level with each skill of each employee;
determine individual skill compliance for each skill of each employee with respect to each skill required by each position based on the employee skill level relative to the skill level required by the position;
determine an employee skill compliance for each employee with respect to each position as a total of the skill level compliances for all skills required by each position; and
assign employees to positions in a manner that maximizes organizational compliance,
wherein organizational compliance is an average of all position compliances that are adjusted by a position weight, and
wherein each position compliance is an employee skill compliance adjusted by a skill weight.

13. The non-transitory computer-readable medium of claim 12, further having computer-readable instructions stored thereon that, if executed by one or more processors, cause the one or more processors to determine a maximum individual skill compliance for a particular skill, indicative of complete individual skill compliance, wherein an employee skill level for a particular skill is greater than the position skill level for the particular skill.

14. The non-transitory computer-readable medium of claim 12, further having computer-readable instructions stored thereon that, if executed by one or more processors, cause the one or more processors to determine a minimum individual skill compliance for a particular skill, indicative of no individual skill compliance, wherein an employee skill level for a particular skill is greater than the position skill level for the particular skill by a predetermined amount.

15. A system for optimizing resource skill compliance, comprising:
a memory operable to store executable instructions; and
a processor coupled to the memory, wherein the processor executes the instructions to:
identify jobs, skills corresponding to the jobs, and resources corresponding to the skills;
associate a job skill level with each skill of each job;
associate a resource skill level with each skill of each resource;
determine individual skill compliance for each skill of each resource with respect to each skill of each job based on the resource skill level relative to the job skill level;
determine resource skill compliance for each resource with respect to each job as a total of the individual skill level compliances for each skill corresponding to each job; and
assign resources to jobs in a manner that optimizes a total of the resource skill compliances for those resources assigned to jobs.
